(19) United States
(12) Patent Application Publication
(10) Pub. No.: US 2020/0388977 A1
(43) Pub. Date: Dec. 10, 2020

(54) DEVICE AND METHOD TO ADJUST TUNABLE LASER PULSES

(71) Applicant: Life Science Inkubator Sachsen GmbH & Co. KG, Dresden (DE)

(72) Inventors: Sebastian STALKE, Dresden (DE); Juergen LINDENER-ROENNEKE, Radevormwald (DE); Katharina WOLF, Ottendorf-Okrilla (DE)

(21) Appl. No.: 16/092,314

(22) PCT Filed: Apr. 14, 2016
(86) PCT No.: PCT/EP2016/058246

§ 371 Date: Oct. 9, 2018

(51) Int. Cl. H01S 3/00; G02F 1/355; H01S 3/30

(52) U.S. Cl. CPC H01S 3/0085; H01S 3/0057; H01S 3/30; H01S 3/0092; G02F 1/355; H01S 3/0071

(57) ABSTRACT

The present invention relates to a device and a method for pulse modulation of laser pulses of tunable laser sources. The invention relates specifically to an arrangement for spectral and/or temporal laser beam manipulation of tunable lasers using nonlinear wave interaction. By using a variable, lens based beam forming section it is possible to manipulate a laser pulse provided by a tunable laser source (i.e. tunable in pulse energy, temporal pulse length and/or wavelength) or different laser sources (i.e. different with respect to pulse energy, temporal pulse width and/or wavelength) in such a manner, that nonlinear wave interaction can occur in the most efficient way. The beam forming section according to the invention allows for adjusting the waist of the laser beam and the focal position of the laser beam inside a cell comprising a nonlinear medium.

### FIELD OF THE INVENTION

The present invention relates to a device and a method for pulse modulation of laser pulses of tunable laser sources. The invention relates specifically to an arrangement for spectral and/or temporal laser beam manipulation of tunable lasers using nonlinear wave interaction. By using a variable, lens based beam forming section it is possible to manipulate a laser pulse provided by a tunable laser source (i.e. tunable in pulse energy, temporal pulse length and/or wavelength) or different laser sources (i.e. different with respect to pulse energy, temporal pulse width and/or wavelength) in such a manner, that nonlinear wave interaction can occur in the most efficient way. The beam forming section according to the invention allows for adjusting the waist of the laser beam and the focal position of the laser beam inside a cell comprising a nonlinear medium.

### BACKGROUND OF THE INVENTION

Since lasers have been developed in 1960, they became ubiquitous and found utility in various fields of application. Especially in the field of chemistry, biochemistry and biology a lot of spectroscopic methods use the advantages of lasers as radiation sources. For convenience especially tunable laser sources which cover, for example, a wide range of wavelengths instead of one wavelength are used. A lot of laser sources are commercially available and all of them have specific properties (i.e. wavelength, pulse energy, pulse duration) and customers have to decide which system is suitable for their application. A given laser source may vary in said specific properties, on purpose, due to a wanted tunability in said specific properties and/or, unwillingly, by i.e. unwanted oscillations, misalignment, decay of laser active material/pumping sources and/or different intrinsic gain of different laser active materials (i.e. Rhodamine laser dyes have a higher gain than Coumarin laser dyes).

A laser can be classified to operate in continuous wave or pulsed mode. Preferably, laser sources used according to the invention operate in pulsed mode. The temporal and spectral characteristics of laser pulses can be adjusted by specific nonlinear processes, with the involvement of specific optical elements. The pulse duration of laser pulses, for example, is shortened by using stimulated Brillouin scattering (SBS) or stimulated Raman scattering. With stimulated Raman scattering a shift of the wavelength of the laser pulse is obtained additionally. Some applications need a white light continuum (WLC) instead of a small band of wavelengths. For this purpose the spectral characteristics of the laser pulse can be manipulated in such a way that the spectral width of a laser pulse is increased. Stimulated Brillouin scattering, stimulated Raman scattering and white light continuum generation take place in a nonlinear medium which, in response to the electric field of an incident light wave, shows a change in density distribution, vibrational state or nonlinear refractive index, respectively.

Time resolution, which is dependent on the temporal pulse width of a laser beam, is crucial for time-resolved experiments. For example, the pulse width of a non-mode-locked pulsed dye laser is in the range of 5-7 ns, mostly depending on the pulse width of the pump laser. To gain access to the UV range, the dye laser output is often frequency doubled with pulse widths of 4-6 ns. Since these pulse widths are on the order of the fluorescence lifetime of most organic and biological substances, the resulting experimental time resolutions will be too big to characterize them based on time-resolved experiments or to separate qualitatively or even quantify the same. The fluorescence lifetime is the time at which the population of excited optical active molecules has decayed to 1/e (=37%) of the maximum population. E.g. Rhodamine 6G has a fluorescence lifetime of 3.7±0.4 ns (in MeOH, 2·10⁻⁴ mol/L) (Bryce-Smith 1979), Insulin and Albumin of 3 and 5 ns, respectively and organic fluorescence labels have fluorescence lifetimes on the order of 1-5 ns. Thus, in case of time resolved fluorescence experiments, sub-nanosecond pulses are frequently used for time correlated single photon counting, streak cameras, or sub-nanosecond CCD cameras. Nanosecond CCD cameras can be gated by sub-nanosecond and shorter laser pulses, like in Kerr-Lens gating or fluorescence up conversion experiments. But also stimulated emission and time-resolved absorption experiments need a good time resolution which is mostly realized with mode-locking or Q-switching. Especially the range between 10 ps and 1 ns can be hardly covered by these techniques. Further, for effects of non-linear optics, such as self-phase modulation, frequency doubling and other nonlinear processes, a shortened electromagnetic pulse is advantageous because it has higher peak intensity than an uncompressed pulse.

Stimulated Brillouin scattering (SBS) is one method to temporarily compress an incident, narrowband nanosecond laser pulse. In the prior art, its simplest embodiment is realized by using a lens which focuses the incident laser beam into a nonlinear medium (i.e. water). Via the process of electrostriction an acoustic wave is generated and once, in the focal region, the threshold for SBS is reached, a phase conjugated mirror is created which reflects back a part of the leading edge of the incident laser beam as a stokes pulse. This back reflected stokes pulse interacts with the acoustic field generated by the now counterpropagating adjacent edge of the incident laser beam. Due to this interaction, the Stokes pulse experiences substantial temporal reshaping while traveling back to the front end of the nonlinear medium. The theoretical limit of SBS pulse compression is the phonon lifetime, which is dependent on solvent properties and excitation wavelength. For example in water at excitation wavelengths of 250 nm and 1000 nm, theoretical limits of pulse compression are 70 ps and 1030 ps, respectively. In ethylene glycol, for the same excitation wavelengths, the lower limits have values of 20 ps and 310 ps, respectively.

SBS is also useful to separate the spectrum from background radiation caused by broadband amplified spontaneous emission and other parasitic amplifications, as the broadband input is not amplified during SBS process.

Stimulated Raman scattering is used to shift the spectrum and to temporarily compress the laser pulse of the laser source. Since spontaneous Raman scattering has a weak signal, stimulated Raman scattering can be used. Due to initial spontaneous inelastic scattering of the incident laser pulse by the optical phonons in the nonlinear medium, Stokes photons are generated, which induce further inelastic scattering of the incident laser pulse in the nonlinear medium. If the frequency difference between the incident laser pulse and the Stokes photons matches a molecular vibration of the nonlinear medium, scattered light at the Stokes wavelength is amplified.

In order to increase the width of the spectrum of a laser pulse, white light continuum (WLC) generation, can be used. Herein, the beam is focused into a nonlinear medium and due to the process of self-phase modulation the spectral bandwidth is increased. For femtosecond laser pulses short interaction lengths (approx. 1 cm) with the nonlinear medium are sufficient, whereas in case of nanosecond pulses long interaction lengths, most preferred in optical fibers, are needed (Raikkonen, et al. 2006). In case of WLC generation the use of a broadband incident laser pulse is favorable for many nonlinear media, but in some cases also a small band incident laser beam is useful (He and Liu 1999). WLC is frequently used in time resolved absorption spectroscopy techniques and laser driven compression experiments (Somekawa, et al. 2011), (Spaulding, et al.).

In order to fully benefit from the processes mentioned above, a maximum efficiency with respect to energy yield and/or pulse compression ratio is key. Therefore, it is necessary that the incident laser pulse provided by the laser source is manipulated in a proper way. The type of manipulation of the incident laser pulse depends on the properties of the laser source. For example, by changing the pulse energy of the incident laser pulse, other optical elements have to be used, to obtain the nonlinear interaction with the desired efficiency. This, for example, was shown in (Xu 2014), where an incident laser pulse with temporal width of 10 ns, energy of 50 mJ and wavelength of 532 nm was compressed by means of SBS to ^{˜}1 ns with nearly Gaussian shape in FC-72 (Fluorocarbon 72), using a focal position of 120 cm for the incident laser pulse. As the energy of the incident laser pulse was increased, the temporal profile had clear deviations from Gaussian shape, which became worse at even higher energies. In this case a different lens, with resulting focal position of 230 cm in FC-72 was used to regain the desired Gaussian shaped temporal pulse envelope.

The dependence of temporal shape of SBS pulse on energy and beam waist of incident laser pulse was, for example, shown in (Schiemann, Ubachs and Hogervorst 1997).

Thus it is not possible for customers to use tunable laser sources and nonlinear media in an efficient way. Substantive rearrangements and different optical elements are necessary to adjust the setup of laser source, optical elements and nonlinear medium to changing physical conditions (i.e. pulse energy, pulse duration, wavelength) of the laser source or different nonlinear media.

Different devices comprising laser sources, optical elements and nonlinear media are already known.

A laser with variable pulse length is known from U.S. Pat. No. 5,648,976 A which comprises a laser oscillator for generating a first laser pulse, a pulse compression element which reflects the first laser pulse by stimulated Brillouin scattering (SBS) as a temporarily shortened pulse back to the laser oscillator for subsequent amplification and back reflection to the pulse compressing medium for further temporal compression. After a given number of compression-amplification cycles the beam is coupled out by an electro-optic modulator.

A wavelength tunable laser based on SBS is known from DE 69 200 538 T2, herein the nonlinear medium consists of a diluted laser dye solution, which, in combination with the SBS phase conjugate back reflection, leads to suppression of amplified spontaneous emission which is usually observed in conventional dye lasers. In contrast to US 005 648 976 A the SBS process takes place extra cavity with varying numbers of dye solution filled SBS cells.

Another way for temporal pulse compression with wavelength tunable laser sources is described in DE 10 393 389 T5, where a KrF laser system is used in combination with SBS, stimulated Raman scattering (SRS) and Four Wave mixing.

A wavelength tunable, flash-lamp pumped dye laser with intra cavity SBS cell is known from U.S. Pat. No. 4,875,219 and is used to improve the beam quality.

Temporal pulse compression, using multiple stimulated scattering is shown in U.S. Pat. No. 20,040,196 878 A1.

Furthermore, short pulse radiation generation via SBS using a XeCl laser is demonstrated in U.S. Pat. No. 4,609,876 A1. Additionally, herein a dependence of temporal shape of SBS signal on the focal position of the incident laser pulse is observed.

However, none of the devices mentioned above address the advantage of a variabel spatial preshaping of the laser beam (i.e. setting focal position and beam waist) to enhance the performance of the nonlinear processes. This variabel preshaping facilitates the incorporation of a device used for the nonlinear interaction into running setups with different and/or tunable laser sources.

By changing different physical conditions of the incident laser source, i.e. pulse energy, temporal pulse width and wavelength (see table 1) but also changing the chemical conditions inside of the cell containing the nonlinear medium, i.e. change of solvent from water to ethylene glycol, the result of nonlinear interaction, i.e. temporal SBS pulse shape, varies accordingly. In non-patent literature, the dependence of temporal shape of SBS pulse on energy and pulse width of incident laser pulse was also observed (Veltchev 2009), (Xu 2014), (Schiemann, Ubachs and Hogervorst 1997), (Wong 2005). In all cases, the input energy dependent temporal profiles of SBS pulses were manipulated/improved by using proper focal positions and/or beam waists.

Furthermore, the variation of optimum focal position with incident energy for highest energy efficiency of the SBS process was described in (Kong, et al. 2010) and (Nori 1998).

Finally, a device for wavelength tunable lasers is described in (Brandi, et al. 2003), but herein the incident pulse is temporarily compressed and subsequently used to pump an infrared dye with short lifetime (i.e. laser dye styryl).

Accordingly, the present invention aims at providing a device and a method for adjusting the laser pulse of different laser sources or tunable laser sources in such a way, that the obtained laser pulse is adjusted concerning its physical properties, i.e. spectral characteristics and/or its temporal characteristics.

### SUMMARY OF THE INVENTION

The invention provides a device and a method for compressing/manipulating laser pulses from different or tunable (i.e. pulse energy, temporal pulse width and wavelength) lasers, for example a dye laser, by using a combination of a variable, lens based beam parameter forming section (i.e. focal position and beam waist) and nonlinear wave interaction, i.e. stimulated scattering.

Therefore a device is proposed for modulating a laser pulse comprising
at least one laser source,
a laser beam separation or outcoupling section,
a laser beam forming section comprising at least two lenses,
a cell containing a nonlinear medium and
optional a section of optical elements containing at least one lens and/or at least one mirror positioned in the optical path behind the cell containing a nonlinear medium,
   wherein at least one of the at least two lenses of the laser beam forming section is movable in the direction of the optical path in a way that the beam waist and the focal position of the laser beam inside the cell containing the nonlinear medium are adjusted depending on the properties of the initial laser beam and the type of nonlinear medium to adjust the beam parameters.

By using the device according to the invention a method to compress and adjust laser pulses from different or tunable (e.g. pulse energy, pulse width and wavelength) laser sources is provided. The proposed method comprises the steps:
generating an initial laser beam,
optionally rotating the polarization of the laser beam,
shaping the laser beam waist,
shaping the focal position of the laser beam,
bringing the laser beam into a nonlinear medium inside a cell and
coupling out an adjusted beam,
   wherein the laser beam is focused into the nonlinear medium for nonlinear interaction and the beam waist and the focal position of the beam inside the nonlinear medium are adjusted depending on the properties of the initial laser beam and the type of nonlinear medium.

With regard to the invention the properties of a laser pulse are described by its pulse energy and/or its spectral and/or temporal characteristics. Spectral characteristics meaning the wavelength, spectral shape and spectral width of a laser pulse. The temporal characteristics comprise the temporal pulse length (i.e. full width half maximum FWHM) and the temporal pulse shape.

With regard to the invention the properties of a nonlinear medium are described by its refractive index and its gain factor for a specific nonlinear process, for example.

In an embodiment the method and the device according to the invention are used in a or with a conventional laser system, wherein the laser parameters of the initial laser pulse are adjustable. Thus the device and the method provided by the invention can be used in an efficient way with the equipment customers already have in their labs. This allows e.g. to cover a broader timescale in spectroscopic measurements in a way which is easy to handle.

In a preferred embodiment of the invention the device and method of the invention are used to manipulate the pulse length of the initial laser pulse generated by the laser source in a way that the pulse length is shortened.

In a further embodiment of the invention the device and the method of the invention are used to manipulate the spectral purity of the initial laser pulse in a way that the spectral purity is increased.

In a further embodiment the device and method of the invention are used to manipulate the pulse width and the wavelength of the initial laser pulse at the same time.

Furthermore the device and the method according to the invention are used to manipulate the spatial intensity profile of the initial laser pulse in a way to improve the spatial intensity profile.

A short pulse length, high spectral purity and optimal spatial intensity profiles are properties which are preferred in most spectroscopic methods, thus preferably the device and the method according to the invention are used in time resolved spectroscopy such as e.g. time resolved fluorescence spectroscopy, time-resolved absorption spectroscopy and time-resolved emission spectroscopy as described above. The shortened length of the laser pulses obtained by the device and the method according to the invention enable time-resolved spectroscopy measurements with e.g. fluorescence labels with short fluorescence lifetimes, e.g. below 5 ns.

Further, the device and the method according to the invention can be used in connection with laser ionization, specifically, in REMPI (Resonance enhanced multi photon ionization) experiments like RESS-REMPI or REMPI-TOFMS or other mass spectrometry ionization techniques such as MALDI (matrix assisted laser desorption ionization).

Even further, the device and the method according to the invention can be used for two- and multi-photon absorption, laser induced plasma spectroscopy, laser induced photoacoustic spectroscopy, surface chemistry, nonlinear microscopy and for the study of reaction dynamics with dissociation-fluorescence-excitation experiments.

The white light continuum which is generated according to the invention can be used for steady state and transient absorption with CCD cameras.

Furthermore, the lens system described in the present invention can be useful in laser materials processing, for example it is possible to maintain the same focal diameter, independent of focal position, by readjusting the beam waist. It is also possible, that the lens system is useful in laser surgery, for example if different, controllable, focal diameters are required for the same focal position.

### DETAILED DESCRIPTION OF THE INVENTION

The invention provides a device and a method for compressing/adjusting laser pulses from tunable (pulse energy, pulse width and wavelength) lasers, for example a dye laser, by using a combination of a variable, lens based beam parameter forming section (i.e. focal position and beam waist) and nonlinear wave interaction, i.e. stimulated scattering. Therefore a device for adjusting a laser pulse is provided, comprising
at least one laser source,
a laser beam separation or outcoupling section,
a laser beam forming section comprising at least two lenses,
a cell containing a nonlinear medium and
optional a section of optical elements containing at least one lens and/or at least one mirror positioned in the optical path behind the cell containing a nonlinear medium,
   wherein at least one of the at least two lenses of the laser beam forming section is movable in the direction of the optical path in a way that the beam waist and the focal position of the laser beam inside the cell containing the nonlinear medium are adjusted depending on the properties of the initial laser beam and the type of nonlinear medium to adjust the beam parameters.

The initial laser pulse is generated by a laser source, preferably by a laser source which is tunable or can vary with respect to the pulse energy and/or the temporal and/or the spectral characteristics. Preferably the initial laser beam is generated by a laser source, wherein said laser source is tunable or can vary with respect to the pulse energy and/or the temporal pulse shape and/or the wavelength of the pulse and/or the divergence and/or the spatial shape of the pulse.

Suitably, said laser source comprises one tunable laser or a combination of at least two lasers. In said combination the at least two lasers are tunable or non tunable. It is also possible that said combination of at least two lasers comprises one tunable and one non tunable laser. In a preferred embodiment, the laser source consists of one tunable laser. In another preferred embodiment, the laser source comprises a combination of two lasers, selected from the group consisting of:
two tunable laser,
two non-tunable lasers,
one tunable and one or more non-tunable lasers, and
one non-tunable laser and one or more tunable lasers.

Even preferably, the laser source may comprise 3, 4, 5, 6, 7, 8, 9 or 10 lasers, wherein any combination of tunable and non-tunable lasers may be comprised.

The laser source can be a dye laser, a solid-state laser, a gas laser or an optical parametric oscillator, or a combination thereof, for example.

In a further embodiment the device comprises at least one laser beam mirror after the laser source. Preferably the laser beam is reflected by two broad-band laser mirrors, which allow the proper alignment of the laser beam into the device. To aid the alignment, at least one iris diaphragm can be placed behind the second laser mirror. In a preferred embodiment two iris diaphragms are placed behind the alignment mirrors. The first iris diaphragm can be placed close behind the second laser mirror, whereas the second iris diaphragm can be placed at some distance to the first iris diaphragm. In a further preferred embodiment three iris diaphragms are used, whereas the first iris diaphragm is placed close behind the last alignment mirror, the second iris diaphragm is placed in front of the cell containing the nonlinear medium and the third iris diaphragm is placed behind said cell.

The device further comprises a laser beam separation section or outcoupling section, which comprises optical active materials. Said optical materials are selected from a group consisting of polarization selective elements, polarizing elements, mirrors with high reflectivity for the input wavelength and high transmittance for the output wavelength (i.e. dichroic mirror) and/or prisms. Polarization selective elements can be selected from polarizers, glass plates, nonlinear crystals or dichroic mirrors, for example. Polarizers (i.e. cubic, Glan-Taylor etc.) are very efficient in coupling out the laser beam but may be destroyed when high input energies are used. Glass plates in contrast have a high tolerance with respect to high input energies but are not as efficient in coupling out the laser beam. Nonlinear Crystals are very expensive optical elements. In dependence of the polarization of the laser beam frequency doubling takes place. Since the frequency doubled laser beam has another wavelength in comparison to the incident laser beam both can easily be separated from each other via an additional optical element, e.g. a prism. A dichrotic mirror is characterized by a high outcoupling efficiency and a good tolerance against high input energies but does not work for every wavelength.

A polarizing element can be a waveplate, especially a waveplate which is tunable with respect to the wavelength or a nonlinear crystal. Preferably a waveplate is used as polarizing element. Most preferably a tunable waveplate is used as polarizing element since they work over a wide range of wavelength in a highly efficiency way. A nonlinear crystal can also be used as polarizing element since not only the frequency of the laser beam passing the nonlinear crystal is doubled but also the polarization of the laser beam is rotated by 90°.

Due to different physical (pulse energy, pulse width and wavelength) and chemical (nonlinear medium) parameters by using a tunable laser source and different nonlinear media, respectively, it is necessary to adjust the focal position inside of the cell containing the nonlinear medium and the beam waist at the entrance of the cell. Therefore, the beam parameters of the laser beam such as beam divergence and beam waist have to be shaped. Surprisingly, it was found that all necessary adjustments can be done by using an inventive lens system. Therefore the device comprises a laser beam forming section, comprising said lens system. Preferably this section comprises at least two lenses. In a preferred embodiment at least one of the at least two lenses of the laser beam forming section is movable in the direction of the optical path. By moving said lens the beam waist and the focal position of the laser beam inside the cell containing the nonlinear medium are adjusted depending on the properties of the initial laser beam and the type of nonlinear medium. In a preferred embodiment the laser beam forming section comprises three lenses, wherein at least one lens, preferably two lenses are movable. The lenses of the beam forming section are selected from a group consisting of concave and convex lenses. Preferably the beam forming section comprises one concave and two convex lenses. By using these lenses according to the invention, the focal position and the waist of the beam can be set independently over a wide range. This step is important to achieve optimal performance of the nonlinear interaction between the initial laser pulse and the nonlinear medium.

This feature of the invention has several advantages. For example, the temporal profile of a laser pulse which is generated by stimulated Brillouin scattering can be shaped. Furthermore, the energy efficiency of the conversion of the input pulse to the output pulse can be optimized.

The device according to the invention comprises a cell encapsulating the nonlinear medium. The cell may be a cell comprising a hollow body. Preferably, the body of the cell consists of a nonlinear medium resistant material like glass and/or metal and/or Teflon. The body has an elongated shape, preferably the shape of a cylinder, especially a straight cylinder. In an embodiment according to the invention said cell comprises a length in the range of 10 cm to 3 m, 20 cm to 2 m or 50 cm to 1 m. The diameter of the cell is in the range of 1 cm to 10 cm, 2 cm to 9 cm, 3 cm to 8 cm, 4 cm to 7 cm or 5 cm to 6 cm.

The front and rear end of the cell suitably consists of a light transmitting (UV-IR) material i.e. glass. Thereby the front window is used for coupling in the incident beam as well as for coupling out the generated SBS-Beam and/or backward stimulated Raman scattering. The rear window allows to couple out the resulting white light continuum and/or the forward stimulated Raman scattering.

In a preferred embodiment the cell containing the nonlinear medium is equipped with removable caps on the front end and/or with removable caps on the back end of the body. Thus at least at one end face the body can be opened and the base of the cylinder can be removed. Preferably, the body and the cap can be connected by a thread. Further preferably, the body comprises an inner or outer thread at least at one end face and the cap comprises an outer or inner thread, respectively, wherein said thread is formed such that the cap can be screwed in or on to the body respectively, at least at one end face. The outer and/or inner threads of the cap can comprise Teflon. Teflon is preferred because it is characterized by a high chemical resistance. The inner/outer threads of the body can comprise glass. In a preferred embodiment, the body of the cell comprises removable caps as described above at the front and at the rear end.

In a preferred embodiment the removable caps on the front end and/or on the rear end of the cell containing the nonlinear medium are equipped with optical active materials. Said optical active materials are selected from a group consisting of a mirror, a lens, a filter, a flat window, a flat Brewster angled window, a curved window, a window which is at least partially coated on the inside with a high reflective material, or a focussing mirror.

A Brewster angled window is a window which is positioned in the Brewster angle of approximately 30°-40° (most preferred 35°) with respect to the optical path (55° with respect to the angle between optical axis of the window and the optical path of the laser beam). Thereby reflection losses are reduced in comparison to a conventional window for a certain polarization of the laser beam. Therefore higher energy is available for the nonlinear interaction inside the nonlinear medium and the risk to destroy optical elements in the optical path due to high intensity back reflections is minimized.

Since the cap at the front end and/or at the rear end of the body can comprise optical elements according to the invention the number of optical elements in the whole device can be decreased and therefore reflection losses at optical interfaces are reduced. A cell with curved windows is disclosed in DE 3835347 C2. Due to the curved window, the nonlinear medium forms a liquid condensing lens which is used to excite stimulated scattering processes. Nevertheless, since the windows are not changeable, this device lacks flexibility with respect to adaption to different focal values of the liquid lens, because in such a case the whole cell has to be changed. Furthermore, if the entrance and/or the exit window get damaged, the whole cell needs to be replaced. Additionally anti-reflective coatings have to be applied to the whole cell instead of just the windows.

The cell described in the present invention has a higher flexibility since at least one base can comprise optical elements such as mirrors, focusing mirrors or fully or partially coated windows. Additionally the optical elements can be placed on a removable cap. Furthermore windows having adjustable thickness and high optical flatness can be used. Additionally or as an alternative measure, the base can be coated by an anti-reflective coating without the need that the whole body of the cell is coated by the anti-reflective coating. Further, the cell can be filled easily via the opening. Another advantage by using such an embodiment is parallel cooling of the embedded optical elements and thereby a higher damage threshold.

The nonlinear medium in the cell is preferably a solvent or a mixture of solvents, a solution of non-absorbance compounds, a liquid crystal or ionic liquid. In a preferred embodiment, the pulse-compressing medium inside the cell is a medium having a low particle content (i.e. impurities, for example dust and the like) to prevent from optical breakdown. A suitable material of the pulse-compressing medium can be or comprise water or ethylene glycol. The latter having a shorter phonon lifetime, leading to shorter pulse width limits. In general, to achieve high performance of stimulated Brillouin scattering (SBS), the nonlinear medium should have a large density, a large electrostrictive constant and high threshold for optical breakdown. As a matter of course the medium should have a high transparency for the used wavelengths. In order to optimize for white light continuum generation, solvents, mixtures or solutions with high third order susceptibilities such as DMSO (dimethyl sulfoxide) or acetone or β-Carotene solutions and the like can be used. In order to optimize for stimulated Raman scattering generation, solvents, mixtures or solutions with high Raman gain such as DMSO or ethanol or ethylene glycol are used.

The device comprises in a further embodiment a section of optical elements behind the cell containing the nonlinear medium. Said optical elements suitably comprise at least one lens and/or at least one mirror.

In a further embodiment the device is used for white light continuum generation. Here, the initial beam, which travels together with the generated white light continuum through the medium, is filtered out by optical elements, such as short pass, band pass or most preferred notch-filters, behind the cell. To account for the different pump wavelengths coming from the laser source, a filter wheel or the like with several filters is advantageous. Prisms and/or gratings in combination with spatial wavelength filtering may also be useful. Preferably, the beam which travels through the medium is collimated by a lens and/or lens system. The lens is mounted on a delay line to set a distance, which is chosen such that a proper/optimum collimation is achieved. The same holds true for a lens system. Preferably the lenses are achromatic or a lens system for collimation is used which can comprise non-achromatic lenses. Since the white light continuum consists of different wavelengths, chromatic aberration is observed when passing a non-achromatic lens. That means every wavelength of the white light continuum has a different divergence/focal position, thus it is not easy to collimate the white light continuum beam. The chromatic aberration is minimized by using an achromatic lens or a lens system which can comprise non-achromatic lenses.

In a further embodiment, the device is used for generating stimulated Raman scattering. Therefore, the original beam, which travels together with the generated forward stimulated Raman scattering radiation through the medium, is filtered out by optical elements, such as short pass, band pass or most preferred notch-filters, behind the cell. To account for the different pump wavelengths coming from the laser source, a filter wheel or the like with several filters is advantageous. The fundamental beam may also be filtered from the generated stimulated Raman scattering by using prisms or gratings together with spatial wavelength filtering. Preferably, the beam which travels through the medium is collimated by a lens. The lens is mounted on a delay line to set a distance, which is chosen such that a proper collimation is achieved.

Another embodiment of the device of the invention can be used to allow for multiple reflections of the pulse through the cell and therefore increases the effective interaction length of the cell. This is advantageous if the incident laser pulse has a longer pulse width or if someone wants to use shorter cells due to limited space. If the front end of the cell is a window and the rear end of the cell is a mirror or a mirror is placed behind a cell with a window at the rear end, the effective interaction length of the cell can be increased up to two times in small steps by using the lens system. If the front end of the cell is a partially reflective coated window or a sliced mirror is placed in front of a cell with a normal window and the rear end is a mirror, or a mirror is placed behind a cell with a window at the rear end, the focal position in the nonlinear medium can be set from a few cm to nearly infinity in small steps with nods close to the rear and front end of the cell as this would damage the optical elements.

Preferably, in the two examples mentioned above, the optical elements are incorporated into the cell, for example by using base caps, in order to avoid reflection losses at optical interfaces and to maximize the interaction length in the nonlinear medium.

In one embodiment of the device according to the invention a convex lens is used as optical element behind the cell. The laser beam is focused by said convex lens into another cell containing a nonlinear medium, wherein said second cell contains the same nonlinear medium as the first cell. Alternatively a focusing mirror can be used to redirect the beam into the first cell or a second cell or a rear base cap is used as focusing mirror to redirect the beam into the first cell.

Preferably, the optical elements of the device, i.e. the polarization selective elements, the polarizing elements, the lenses and/or the windows are at least partially broadband antireflective coated, to avoid energy losses due to reflection on optical elements. Most preferably the coating is on the inner surface of the cell.

In one embodiment the invention provides a device for generating stimulated Brillouin scattering, a device for generating a white-light continuum and a device for generating stimulated Raman scattering from an incident laser pulse.

Another embodiment of the invention provides a device for generating a white-light continuum as well as stimulated Raman scattering at the same time.

By using the device according to the invention a method to compress and adjust laser pulses from tunable (e.g. pulse energy, pulse width and wavelength) laser sources is provided. The proposed method comprises the steps:
generating an initial laser beam,
optionally rotating the polarization of the laser beam,
shaping the laser beam waist,
shaping the focal position of the laser beam,
bringing the laser beam into a nonlinear medium inside a cell and
coupling out an adjusted beam,
   wherein the laser beam is focused into the nonlinear medium for nonlinear interaction and the beam waist and the focal position of the beam inside the nonlinear medium are adjusted depending on the properties of the initial laser beam and the type of nonlinear medium.

The initial laser pulse is generated by a laser source which is preferably, tunable with regard to pulse energy, temporal pulse width and pulse wavelength. Suitable laser sources can be a dye laser, a solid state laser, a gas laser or an optical parametric oscillator, for example.

Optionally the laser pulse is reflected by at least one mirror into the laser beam separation section. Preferably the laser pulse is reflected by two broad-band laser mirrors. To aid the alignment, at least two iris diaphragms can be placed behind the second laser mirror. The first iris diaphragm can be placed close behind the second laser mirror, whereas the second iris diaphragm can be placed at some distance to the first iris diaphragm. In a further preferred embodiment three iris diaphragms are used, whereas the first iris diaphragm is placed close behind the last alignment mirror, the second iris diaphragm is placed in front of the cell containing the nonlinear medium and the third iris diaphragm is placed behind said cell.

In a preferred embodiment the laser beam passes through a polarization selective element, i.e. a polarizer or at least one glass plate. Suitable polarizers are, e.g. cubics like Glan-Taylor prisms.

In a preferred embodiment of invention the polarization of the initial laser beam is rotated by at least one spectrally tunable or non-tunable waveplate.

Thereafter the beam parameters, waist and focal position, of the laser pulse are adjusted by the beam forming section of the device according to the invention. Said beam forming section comprises a lens system. Said lens system comprises at least two lenses, wherein, preferably, at least one lens is movable. It is also possible that more than one lens is movable or all lenses of the lens system are movable.

In a further embodiment of the method of the invention the waist and/or focal position of the initial laser beam is modulated by adjusting the position of the lenses in the lens system of the beam forming section. According to the invention, the beam waist and the focal position can be adjusted independently of each other.

By using the method according to the invention the spatial shape of the initial beam is adjusted by the beam forming section, which comprises at least two lenses which are selected from a group consisting of focusing and defocusing lenses and which are movable in the direction of the optical path.

In a preferred embodiment at least one of the at least two lenses of the laser beam forming section is movable in the direction of the optical path and the other one is fixed. By moving said lens the beam waist and the focal position of the laser beam inside the cell containing the nonlinear medium are adjusted depending on the properties of the initial laser beam and the type of nonlinear medium. In a preferred embodiment the laser beam forming section comprises three lenses, wherein at least one lens, preferably two lenses are movable. The lenses of the beam forming section are selected from a group consisting of concave and convex lenses. Preferably the beam forming section comprises one concave and two convex lenses. By using these lenses according to the arrangement of the invention, the focal position and the waist of the beam can be set independently over a wide range. Since the nonlinear interaction between the nonlinear medium and the incident laser pulse is sensitive to the focal position and beam waist of the laser pulse, this step is important for an optimal performance of the nonlinear interaction between the initial laser pulse and the nonlinear medium.

The method of the invention is suitable to manipulate laser pulses from tunable laser sources. Tunable laser sources can vary in pulse energy, pulse width and/or wavelength of the pulse. According to the invention the focal position and/or beam waist of the incident laser beam is adjusted by adjusting the position of the lenses in the lens system of the beam forming section in dependence of the physical properties of the initial laser beam.

After spatial shaping of the initial laser pulse coming from the laser source by the lenses of the beam forming section, the laser pulse is brought into a nonlinear medium inside a cell. A nonlinear interaction can take place between the nonlinear medium and the laser pulse. Due to this interaction a manipulation of the incident laser pulse happens.

Of course, the performance of the manipulation of the initial laser pulse of the laser source also depends on chemical parameters of the nonlinear medium used. According to the invention the focal position and/or beam waist of the laser beam in the nonlinear medium is adjusted by adjusting the position of the lenses in the lens system of the beam forming section in dependence of the chemical properties, such as refractive index or gain, of the nonlinear medium in the cell.

Further according to the invention, it is possible that the focal position of the laser beam in the nonlinear medium is adjusted by positioning of the at least one focusing lens and/or at least one focusing mirror comprised in the beam forming section.

After passing the nonlinear interaction inside the cell, the adjusted beam is coupled out. Said action takes place via the front end of the cell and/or via the rear end of the cell.

In another embodiment of the invention optionally a section of optical elements is positioned behind the cell. Said optical elements are, e.g. selected from a group comprising a lens, a mirror or a filter. Said filters are for example a short pass, band pass or most preferred a notch-filter.

In an embodiment of the invention the laser pulse leaving the first cell containing a nonlinear medium through the rear end of the cell is focused by a lens into a second cell containing a nonlinear medium. In this case the parametric interaction takes place in the second cell and the first cell. The nonlinear media in the first and in the second cell can be equal or different. Said embodiment of the invention can be used as a generator amplifier embodiment for high input energies.

In a preferred embodiment the method according to the invention is used to generate stimulated Brillouin scattering. Therefore the method of the invention refers to a method for generating a laser pulse, which comprises the steps of generating a first laser beam (pumping section [pump laser/dye laser or OPO etc.]), passing of the beam through a polarizer (i.e. cubic (Glan-Taylor prism), glass plate etc.) rotating the polarization, especially by a tunable waveplate, adjusting the beam parameters by a lens system and at least partially temporarily shortening the laser beam in a pulse compressing medium. The generated back reflected stimulated Brillouin scattering beam is rotated again and finally coupled out and shows a compressed temporal pulse width. A high-quality, shortened pulse is obtained.

According to the invention, stimulated Brillouin scattering is generated due to nonlinear interactions between the laser pulse and the nonlinear medium. Due to different physical parameters such as pulse energy, temporal pulse width and wavelength of the pulse and chemical parameters such as different nonlinear media by using a tunable laser source and different nonlinear media, it is necessary to adjust the focal position inside the cell containing the nonlinear medium and the beam waist at the entrance of the cell. Both parameters are regulated by adjusting the positions of the lenses in the lens system of the beam forming section.

In a preferred embodiment of the method of the invention the beam forming section comprises three lenses, preferably a concave and two convex lenses. Preferably at least two of said lenses are movable on a delay line and adjustable with regard to the optical path.

In a further preferred embodiment of the method of the invention comprises a concave lens, a first convex lens and a second convex lens, wherein the concave lens and the first convex lens are moved together in the direction of the optical path with respect to the second convex lens which is fixed, while the distance between the concave and the first convex lens is kept constant. Preferably, the concave lens and the first convex lens are mounted on a sliding delay line that can be moved in the direction of the optical path back and forth, to set a distance L2 between the first convex lens and the second convex lens. Further, the concave lens is movable with regard to the first convex lens, to set a second distance L1. For this purpose the concave lens is mounted on a separate sliding delay line and can be moved in the direction of the optical path back and forth. In this way, L1 and L2 can be set independently. Correspondingly, by choosing proper values for L1 and L2, both the position of beam focus and beam waist at the entrance of the cell comprising the nonlinear medium can be set independently over a wide range. Additionally, a given range can be shifted up or down, if the beam waist is increased or decreased prior entering the beam forming section.

In a further embodiment of the method of the invention the beam forming section comprises a concave lens, a first convex lens and a second convex lens, wherein the concave lens is mounted on a sliding delay line and can be moved in the direction of the optical path with respect to the first convex lens, to set distance L1. The second convex lens is mounted on a sliding delay line too and can be moved in the direction of the optical path with respect to the first convex lens, to set distance L2.

Furthermore the order of the lenses can be changed according to the invention. In this case the range over which the position of the beam focus and beam waist can be set is increased. The order of the lenses can be:
a first convex lens, a concave lens and a second convex lens,
a concave lens, a first convex lens and a second convex lens or
a first convex lens, a second convex lens and a concave lens

The adjustment of the lens system in the beam forming section is done in the same way independent of the type of nonlinear interaction. Especially the described adjustments are used to generate stimulated Brillouin scattering, stimulated Raman scattering, a white light continuum or a combination thereof.

A laser pulse can be described by its temporal, spectral and spatial intensity distribution, I(t), I(λ) and I(x,y), respectively. In the theoretical optimal case, the time domain signal is Gaussian-shaped. In this case the temporal pulse length can easily be given by the full width at half maximum value (FWHM) of the time domain signal of the laser pulse power. Low FWHM of a Gaussian-shaped pulse meaning short laser pulses which are well suitable for life-time measurements in spectroscopic methods as described else were. The spectrum of a laser pulse describes the signal of the laser pulse power in the frequency domain. In that case a Gaussian-shaped spectrum with a low FWHM describes a pulse having a small bandwidth of wavelengths and a high spectral purity. A small bandwidth of wavelengths and a high spectral purity are desirable for many spectroscopic methods, i.e. wavelength selective excitation.

In a preferred method according to the invention the incident laser pulses are compressed to the optimal temporal pulse length and shape independent of their energies by adjusting the position of the lenses in the lens system of the beam forming section in dependence of the energy of the initial laser pulse using stimulated Brillouin scattering.

Herein, optimal temporal pulse length and shape meaning, as described above, low FWHM values and nearly Gaussian-shaped laser pulses. The theoretical optimal Gaussian-shaped pulse will not be obtained in reality but the shape of the pulse is essentially Gaussian-shaped. This means, according to the invention, a pulse having a shape close to the theoretical Gaussian-shaped pulse is more optimal than another pulse with another shape. Especially, a Gaussian shaped pulse will lead to a better time resolution than log-normal, double pulse like, or even Lorentzian shaped pulses and will be better suitable for mathematical deconvolution of the time resolved spectroscopic data in subsequent data analysis.

Adjustment of optimal focal position for different pulse widths of the initial laser in case of manipulation by means of stimulated Brillouin scattering:

The cell length/focal position has to be chosen such that the whole counter propagating incident laser beam can interact with the Stokes beam. A good estimate is the use of the full width at half maximum (FWHM) of the incident laser pulse. Typical values for Nd:YAG laser wavelengths are given in table 1. Since the incident beam is counter propagating to the Stokes beam and the nonlinear interaction starts in the focal region, only half of the value of FWHM is taken to estimate the proper focal value. Therefore, for a pulse with 10 ns FWHM, the starting focal position is chosen to be 0.5·10 ns·c₀=150 cm. A more precise estimate would take into account the refractive index of the nonlinear medium. By using water and 532 nm input wavelength the starting focal position would be 0.5·10 ns·c₀/n(λ)=0.5.10 ns·c₀/1.3337=112 cm.

TABLE 1
Typical wavelengths (λ), energies (E) and pulse
durations (τ) of commercially available Nd:YAG Lasers.

| | E/mJ | | | | | | | | | | |
|---|---|---|---|---|---|---|---|---|---|---|---|
| λ/nm | 10 Hz | 50 Hz | Mini | τ/ns | n_{quartz} | n_{H2O} | n_{EG} | f_{H2O} | f_{EG} | γ_{H2O} | γ_{EG} |
| 1064 | 650 | 200 | 30 | 8-12 | 1.4496 | 1.326 | 1.4233 | 95.1 | 102.1 | 0.95 | 1.38 |
| 532 | 300 | 70 | 15 | 6-10 | 1.4607 | 1.3337 | 1.4342 | 93.4 | 99.6 | 0.98 | 1.43 |
| 355 | 150 | 30 | 6 | 5-9 | 1.4761 | 1.3426 | 1.4523 | 90.9 | 98.4 | 1.02 | 1.52 |
| 266 | 75 | 15 | 3 | 4-8 | 1.4997 | 1.3569 | 1.4805 | 87.6 | 95.4 | 1.08 | 1.67 |

Refractive indices (n) and expected resulting focal positions (f) using a 70 cm bi-concave quartz lens (532 nm, air) in liquids water and ethylene glycol at corresponding wavelengths are also shown.
Calculated electrostrictive constants γ = (n² − 1)(n² + 2)/3 for the two liquids at different wavelengths are given for comparison.

The final, optimum focal position is also dependent on the input energy as shown in the example experiments and stated from (Veltchev 2009), (Schiemann, Ubachs and Hogervorst 1997), (Xu 2014) and (Wong 2005). The optimum focal position is close to or equals the effective pulse length of the incident laser beam, i.e. the temporal part of the incident laser beam which is capable of significantly interacting with the counter propagating stokes beam by means of electrostriction.

A proposed method to find the optimum focal position by using the lens system is to use one of the starting focal positions mentioned above and then adapting the focal position until the temporal profile stops improving. Subsequently the beam waist is optimized until the temporal profile stops changing. The procedure is repeated until optimum temporal pulse profile is obtained.

Another embodiment of the device of the invention can be used to allow for multiple reflections of the pulse through the cell and therefore increases the effective interaction length of the cell. This is advantageous if the incident laser pulse has a longer pulse width or if someone wants to use shorter cells due to limited space. If the front end of the cell is a window and the rear end of the cell is a mirror or a mirror is placed behind a cell with a window at the rear end, the effective interaction length of the cell can be increased up to two times in small steps. If the front end of the cell is a partially reflective coated window or a sliced mirror is placed in front of a cell with a normal window and the rear end is a mirror, or a mirror is placed behind a cell with a window at the rear end, the focal position in the nonlinear medium can be set from a few cm to nearly infinity in small steps with nods close to the rear and front end of the cell as this would damage the optical elements.

Preferably, in the two examples mentioned above, the optical elements are incorporated into the cell, for example by using base caps, in order to avoid reflection losses at optical interfaces and to maximize the interaction length in the nonlinear medium.

The described embodiment used to reflect the pulse multiple times through the cell can be used to generate stimulated Brillouin scattering, stimulated Raman scattering, a white light continuum or a combination thereof.

In an embodiment of the method of the invention the beam forming section is also useful for efficient compression of very high input energies >50 mJ/pulse. In this case a generator-amplifier setup is favorable. As stated by (Nori 1998), (Schiemann, Ubachs and Hogervorst 1997) and (Yoshida, et al. 2009), the temporal shape of SBS pulses also depends on the beam waist inside the amplifier part. Therefore, the lens system of the beam forming section can be used to collimate the beam at different waists over a wide range and in small steps to prevent SBS inside the amplifier part and to optimize the temporal shape of SBS beam. If the energy of the incident laser beam is changed, the beam waist can be adapted accordingly. The optimum beam waist is also dependent on the Brillouin gain of the solvent, which is dependent on wavelength of the incident laser pulse (see table 1). Thus the waist of the laser beam has to be adapted if the solvent or wavelength of the laser beam is changed. A preferred embodiment of the method of the invention comprises a first cell comprising a nonlinear medium, a convex lens and a second cell comprising a nonlinear medium. After passing the first cell comprising a nonlinear medium, the laser beam is focused by a convex lens into a second cell containing a nonlinear medium. The nonlinear medium in the first and in the second cell can be equal or different.

In a further embodiment of the method of the invention the laser pulse is redirected by a focusing mirror behind the cell comprising the nonlinear medium into the same cell containing the nonlinear medium or another cell containing a nonlinear medium. In a more preferred embodiment said focusing mirror is integrated in the rear end cap of the cell. Additionally said embodiments of the method of the invention can be used to generate stimulated Brillouin scattering, stimulated Raman scattering or a combination thereof.

By regulating the positions in the beam forming section in a suitable way, initial laser pulses which have different physical properties when they leave the laser source are compressed in the same setup using stimulated Brillouin scattering. Setup describes in this context the whole device according to the invention comprising at least one laser source, a laser beam separation or outcoupling section, a laser beam forming section comprising at least two lenses, a cell containing a nonlinear medium and optional a section of optical elements containing at least one lens and/or at least one mirror positioned in the optical path behind the cell containing a nonlinear medium.

Due to a wavelength dependence of refractive indices of lenses and nonlinear medium, the focal position varies accordingly (see table 1). Furthermore, the electrostrictive constant, which influences the Brillouin gain, is wavelength dependent (see table 1). Therefore, the Brillouin threshold intensity of the incident laser pulse changes with changing wavelength. This will change the effective pulse length of the incident laser beam. This can be accounted for by adjusting the lenses in the beam forming section. Therefore, with the method according to the invention laser pulses with different wavelengths are compressed using stimulated Brillouin scattering.

According to the invention the method is used to generate stimulated Brillouin scattering with different nonlinear media. The chemical parameters of the nonlinear medium used influence the efficiency of the nonlinear interaction between the incident laser pulse and the nonlinear medium. Due to different refractive indices of solvents the focal position varies accordingly, furthermore the Brillouin gain is solvent dependent (see table 1 and (Damzen, et al. 2003), (Sutherland 2003)). Therefore the Brillouin threshold changes when changing the nonlinear medium in the cell. This affects the effective pulse width of the incident laser beam.

The quality of the solvent can change by impurities like dust or gases/bubbles which may cause optical breakdown and/or absorption/parasitic scattering. In this case the focal length and position have to be adapted to avoid energy losses and/or bad temporal reshaping. Thus adjustments in the setup have to be done to obtain optimal laser beam manipulation. These adjustments are realized by adapting the positions of the lenses in the beam forming section.

In an embodiment of the method of the invention the lens system of the laser beam forming section can also be used to produce a divergent beam, which is focused back into the same cell at the rear end or can be focused into another cell. Due to an often Gaussian-shaped temporal profile of the incident beam, the Stokes beam, generated in the focal region, faces different photon densities when traveling back through the cell. Especially, at the adjacent edge of the incident Gaussian-shaped beam, the Stokes beam faces a lower induced acoustic field and therefore amplification and temporal reshaping is decreased. In tapered waveguide geometry this situation is further declined due to the comparably large beam diameters in the front region of the cell. To compensate for the lower photon densities of the incident laser beam in the front region of the cell, a divergent beam is created via the beam forming section. Arrangements with different optical elements can be used.

In a preferred embodiment of the method of the invention the laser pulse is redirected by a focusing mirror (or a lens with mirror) behind the cell comprising the nonlinear medium into the cell containing the nonlinear medium. In a more preferred embodiment said focusing mirror is integrated in the rear end cap of the cell. Additionally said embodiments of the method of the invention can be used to generate stimulated Brillouin scattering, stimulated Raman scattering or a combination thereof. By using the beam forming section, the divergence of the beam can be set over a wide range in small steps.

A further embodiment of the method of the invention comprises a first cell comprising a nonlinear medium, a convex lens or focusing mirror and a second cell comprising a nonlinear medium. After passing the first cell comprising a nonlinear medium, the laser beam is focused by a convex lens into a second cell containing a nonlinear medium.

The nonlinear medium in the first and in the second cell can be equal or different. The divergence of the beam can be set over wide range in small steps. The embodiment of the invention to account for a divergent laser beam can be used to generate stimulated Brillouin scattering, stimulated Raman scattering or a combination thereof.

By generating stimulated Brillouin scattering according to the invention the initial laser pulse coming from the laser source is manipulated with regard to its temporal shape and width, its spectral purity and its spatial shape.

The temporal pulse width is manipulated in a way that the pulse length of the initial laser pulse is longer in comparison to the adjusted laser pulse. Thus the pulse is temporarily compressed. Pulse lengths in the range of 0.1-4 ns are obtainable

The spectral purity is manipulated in a way that the spectral shape of the adjusted laser pulse has a higher or at least the same symmetry in comparison to the initial laser pulse. If the spectral width of the initial laser pulse is higher than a few GHz, but not too high to prohibit SBS process, a narrowing of said spectral width is obtained additionally.

The spatial profile of the intensity of the adjusted laser beam is improved in comparison to the initial laser beam. In a way that the spatial intensity distribution gets more localized.

The stimulated Brillouin scattering is backward oriented and leaves the cell containing the nonlinear medium through the front end of the cell. The SBS pulse is coupled out by the waveplate and the polarizer of the beam separation section.

Another aspect of the invention is a method for generating stimulated Raman scattering and comprises the steps of generating a first laser beam (pumping section [pump laser/dye laser or OPO etc.]), adjusting the beam parameters by a lens system and focusing the laser beam in a Raman medium, which is a nonlinear medium. The effected non-linear process in the medium results in frequency shifted and temporarily compressed light which is coupled out at rear and/or front end of the cell containing the nonlinear medium. Especially, the nonlinear medium used for generating stimulated Raman scattering can be the pulse-compressing medium according to the other aspect of the invention such that according to the method for generating stimulated Raman scattering also the method to generate stimulated Brillouin scattering can be used to generate stimulated Raman scattering.

Since stimulated Raman scattering is generated in both directions, backward and forward, two different types of setups can be used for obtaining stimulated Raman scattering pulses. To use the generated backward stimulated Raman scattering, a setup similar to the setup for generation of stimulated Brillouin scattering (SBS) is used. The backward orientated Raman beam goes the same way compared to the SBS beam and therefore it is coupled out of the setup by the wave plate and the polarizer of the beam separation section. Since the stimulated Raman beam has a different wavelength than the incident beam, the tunable wave plate has to be optimized for some intermediate wavelength between incident beam and Raman beam. By omitting the polarizer and the wave plate the stimulated Raman scattering beams can also be coupled out by using a dichroic mirror or a prism.

The generated forward stimulated Raman scattering is coupled out at the rear end of the cell containing the nonlinear medium. The device according to the invention comprises optional additional optical elements in the optical path behind the cell containing the nonlinear medium. Preferably the resulted Raman beam is collimated by a lens in the optical path behind the cell containing the nonlinear medium. In the case of using Stokes and anti-Stokes Raman beams at the same time, a lens system is used to couple out the forward Raman scattering. The incident laser beam is filtered out by at least one prism or grating or, preferably, by using a short pass, band pass or most preferred a notch-filter.

According to the invention stimulated Raman scattering is generated due to nonlinear interactions between the laser pulse and the nonlinear medium. Due to different physical parameters such as pulse energy, pulse width and wavelength of the pulse and different chemical parameters by using a tunable laser source and different nonlinear media, respectively, it is necessary to adjust the focal position inside the cell containing the nonlinear medium and the beam waist at the entrance of the cell. Both parameters are regulated by adjusting the positions of the lenses in the lens system of the beam forming section.

In a preferred method according to the invention stimulated Raman scattering is generated by adjusting the position of the lenses in the lens system of the beam forming section in dependence of the energy of the initial laser pulse.

In another preferred method according to the invention initial laser pulses with different wavelengths are used to generate stimulated Raman scattering.

According to the invention the method is used to generate stimulated Raman scattering with different nonlinear media. The chemical parameters of the nonlinear medium used influence the efficiency of the nonlinear interaction between the incident laser pulse and the nonlinear medium. Thus adjustments in the setup have to be done to obtain an optimal manipulated laser beam. These adjustments are realized by adapting the positions of the lenses in the beam forming section.

Furthermore the temporal shape of the initial laser pulse coming from the laser source influences the efficiency of the stimulated Raman scattering. According to the invention the positions of the lenses in the lens system of the beam forming section are adjustable in dependence of the temporal shape of the incident laser beam.

By regulating the positions in the beam forming section in a suitable way initial laser pulses which have different physical characteristics such as temporal pulse width, wavelength and pulse energy when they leave the laser source are adjusted in the same setup using stimulated Raman scattering. Setup describes in this context the whole device according to the invention comprising at least one laser source, a laser beam separation or outcoupling section, a laser beam forming section comprising at least two lenses, a cell containing a nonlinear medium and optional a section of optical elements containing at least one lens and/or at least one mirror positioned in the optical path behind the cell containing a nonlinear medium.

By generating stimulated Raman scattering according to the invention the initial laser pulse coming from the laser source is manipulated by means of stimulated Raman scattering and as a result is manipulated with regard to its spectral shape and wavelength and temporal shape and/or temporal pulse width.

The pulse length is manipulated in a way that the pulse length of the initial laser pulse is longer in comparison to the adjusted laser pulse. Thus the pulse is temporal compressed. Pulse lengths in the range of a few ps (below 5 ns) are obtainable

The spectral shape is manipulated in a way that the spectral shape of the adjusted laser pulse changes in dependence of the properties of the nonlinear medium in comparison to the initial laser pulse.

Another aspect of the invention is a method for generating a white-light continuum and comprises the steps of generating a first laser beam (pumping section [pump laser/dye laser or OPO etc.]), adjusting the beam parameters by a lens system and focusing the laser beam in a spectral broadening medium. The effected non-linear process in the medium results in spectral broadening and the generated white light is coupled out at the rear end of the setup. Especially, the medium used for generating a white-light continuum can be the pulse-modulating nonlinear medium according to the methods of the invention utilizing stimulated Brillouin scattering and stimulated Raman scattering such that according to the method for generating a white-light continuum also the methods using stimulated Brillouin scattering and stimulated Raman scattering can be used for white light continuum generation.

According to the invention a white light continuum is generated due to nonlinear interactions between the laser pulse and the nonlinear medium. Due to different physical parameters such as pulse energy, pulse width and wavelength of the pulse and different chemical parameters by using a tunable laser source and different nonlinear media, respectively, it is necessary to adjust the focal position inside the cell containing the nonlinear medium and the beam waist at the entrance of the cell. Both parameters are regulated by adjusting the positions of the lenses in the lens system of the beam forming section.

In a preferred method according to the invention initial laser pulses of different energies are used to generate a white light continuum.

In another preferred method according to the invention a white light continuum is generated by adjusting the position of the lenses in the lens system of the beam forming section in dependence of the spectral bandwidth of the initial laser pulse.

Another method according to the invention uses initial laser pulses with different wavelength to generate a white light continuum.

According to the invention the method is used to generate a white light continuum with different nonlinear media. The chemical parameters of the nonlinear medium used influence the efficiency of the nonlinear interaction between the incident laser pulse and the nonlinear medium. Thus adjustments in the setup have to be done to obtain an optimal manipulated laser beam. These adjustments are realized by adapting the positions of the lenses in the beam forming section.

The white light continuum radiation which is generated due to nonlinear interactions between the incident laser pulse and the nonlinear medium in the cell, radiates in the forward direction of the optical path of the whole setup. Thus the adjusted pulse showing a white light continuum leaves the cell containing the nonlinear interaction through the rear end. Said adjusted pulse is collimated by optical elements in the optical path behind the cell containing a nonlinear medium and separated from the initial laser pulse by optical elements in the optical path behind said cell containing a nonlinear medium. The device according to the invention comprises optional additional optical elements in the optical path behind the cell containing the nonlinear medium. Preferably a lens system is used to collimate the white light continuum. In order to filter out the wavelength of the incident laser beam filter, preferably a short pass, band pass or most preferred a notch-filter is used. A combination of prism or gratings with spatial wavelength filtering is also possible.

The pulse generated by the forward stimulated Raman scattering is according to the method of the invention collimated by optical elements in the optical path behind the cell containing a nonlinear medium and separated from the initial laser pulse by optical elements in the optical path behind said cell containing a nonlinear medium.

By regulating the positions in the beam forming section in a suitable way initial laser pulses which have different physical characteristics such as temporal pulse width, wavelength and pulse energy when they leave the laser source are adjusted in the same setup by nonlinear interactions generating a white light continuum. Setup describes in this context the whole device according to the invention comprising at least one laser source, a laser beam separation or outcoupling section, a laser beam forming section comprising at least two lenses, a cell containing a nonlinear medium and optional a section of optical elements containing at least one lens and/or at least one mirror positioned in the optical path behind the cell containing a nonlinear medium.

By simply adjusting the position of the lenses in the beam forming section the method according to the invention is suitable for laser pulses generated by tunable laser sources. Such laser sources can vary within the temporal pulse width, wavelength and energy. All of these different physical parameters are accounted for by the proposed method according to invention. This represents an easy to handle and economic way for customers to account for different properties of initial laser sources and nonlinear media.

Furthermore, according to another aspect the invention provides a method in which stimulated Brillouin scattering can be obtained as well as at the same time a white-light continuum and stimulated Raman scattering is created.

In an additional embodiment, the setup is useable for generation of SBS and white light continuum together at the same time. Thereby it is necessary to find a compromise between optimal adjustment for white light continuum and optimal adjustment for SBS. By concentrate for optimal conditions for white light continuum and omitting SBS it is preferably to use a broad band laser source as initial laser. By concentrate for optimal conditions for SBS and neglecting white light continuum it is preferable to use a small band laser source as initial laser.

In an additional embodiment, the setup is useable for generation of SBS and stimulated Raman scattering together at the same time. Thereby it is necessary to find a compromise between optimal adjustment/optimal solvent choice for stimulated Raman scattering and optimal adjustment/optimal solvent choice for SBS. By concentrate for stimulated Raman scattering and neglecting SBS it is preferable to use a small band mirror instead of a broad band mirror for the alignment of the beam and to omit the waveplate and the polarizer in the beam separation section.

In an additional embodiment, the setup is useable for generation of SBS, stimulated Raman scattering and white light continuum together at the same time. Thereby it is necessary to find a compromise between optimal adjustment/optimal solvent choice for stimulated Raman scattering, SBS and white light continuum.

In an additional embodiment, the setup is useable for generation of stimulated Raman scattering and white light continuum together at the same time. Thereby it is necessary to find a compromise between optimal adjustment/optimal solvent choice for stimulated Raman scattering and white light continuum.

In an additional embodiment of the invention at least two devices are connected in series, in order to further shorten the temporal pulse width (i.e. by generating SBS in the first device and using this output to pump the second device, in which SBS and/or SRS can be excited) or to produce sub-nanosecond white light continuum (i.e. by generating SBS in the first device and using this output to pump WLC in the second device).

In the following the device and method according to the invention are explained in more detail in 12 figures and 4 examples.

### BRIEF DESCRIPTION OF THE DRAWINGS

FIG. 1 shows a device according to the invention.

FIG. 2 shows different embodiments of the beam forming section.

FIG. 3 shows different base caps.

FIG. 4 shows the arrangement for multiple reflections through the cell containing the nonlinear medium.

FIG. 5 shows the use of the beam forming section to account for high input energies of the incident laser pulse by varying the waist of the laser pulse.

FIG. 6 shows embodiments of a part of the invention using divergent laser beams.

FIG. 7 shows an embodiment to extract generated backward stimulated scattered Raman radiation.

FIG. 8 shows an embodiment of the invention used for white light continuum generation.

FIG. 9 shows temporal profiles of a laser pulse obtained by using stimulated Brillouin scattering as nonlinear interaction at different focal positions of the incident laser pulse for two different energies of the incident laser pulse.

FIG. 10 shows temporal profiles of a laser pulse obtained by using stimulated Brillouin scattering as nonlinear interaction for two different energies of the incident laser pulse in dependence of the positions of the lenses in the beam forming section.

FIG. 11 shows temporal profiles of a laser pulse obtained by using stimulated Brillouin scattering as nonlinear interaction in dependence of the pulse waist of the incident laser pulse.

FIG. 12 shows example spectral profiles of generated white light continuum in water using broadband input laser pulse.

FIG. 13 shows example spectral profiles of generated white light continuum in water using narrowband input laser pulse.

### DETAILED DESCRIPTION OF THE DRAWINGS

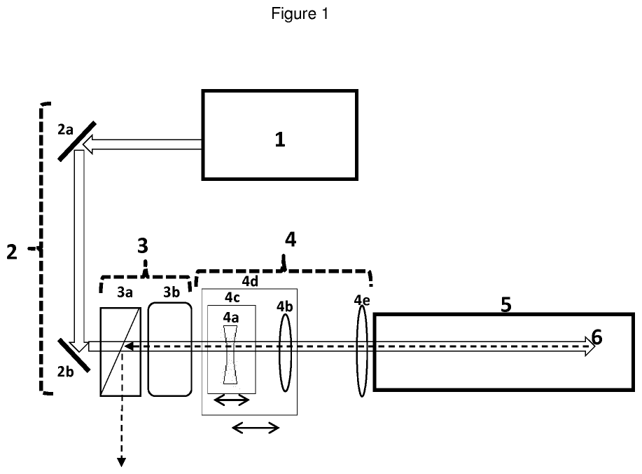

In one embodiment the Invention is used to generate stimulated Brillouin scattering. FIG. 1 shows an embodiment of the invention used to generate stimulated Brillouin scattering. The embodiment comprises a tunable pulsed laser source (1). The laser source (1) generates a first laser beam which is directed to an alignment section (2) which comprises an alignment mirror. Said alignment mirror comprises two broadband laser mirrors (2a) and (2b) each having a high damage threshold. The alignment mirrors (2a) and (2b) are used to couple the first laser beam into an arrangement of a beam separation section, a beam forming section and a cuvette or cell (5). The beam separation section comprises a polarizer (i.e. cubic (Glan-Taylor), glass plate) (3a) and a tunable waveplate (3b).

The beam forming section comprises at least two lenses. In a preferred embodiment, three lenses, a concave lens (4a) (i.e. −f=2 cm to 10 cm), a convex lens (4b) (i.e. f=5 cm to 50 cm), and a second convex lens (4e) (i.e. f=20 cm to 100 cm) are used. Further, the beam forming section of the embodiment consists of a lens system including at least 2 lenses with adjustable distance. In the preferred embodiment the use of at least 3 lenses with adjustable distances is recommended, due to higher degree of freedom i.e. independently adjusting focal position and beam waist. The beam forming section focuses the initial beam into the cell (5) which is filled with a pulse-compressing nonlinear medium. The generated back reflected SBS beam will be polarized again by the tunable waveplate (3b) such that the resulting polarization of the beam is polarized by 90° with regard to the first laser beam. The laser beam will leave the polarizer (3a) at a direction orthogonal to the direction of the incident laser pulse. A high-quality, tunable, shortened pulse is obtained.

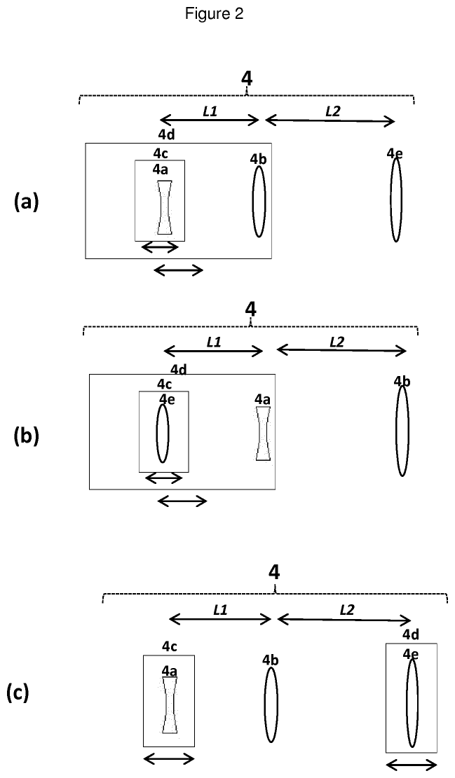

The detailed function of the beam forming section (4) is depicted in FIG. 2. FIG. 2(a) illustrates one embodiment according to the invention of the beam forming section. The concave lens (4a) and the convex lens (4b) are movably mounted on a delay line (4d) and adjustable with regard to the optical path. The box (4d) around the lenses (4a) and (4b) illustrates that both lenses are moved with respect to lens (4e). Thus, the concave lens (4a) and the convex lens (4b) are moved in the direction of the optical path. The concave lens (4a) and the convex lens (4b) are mounted on the sliding delay line (4d) that can be moved in the direction of the optical path back and forth, to set distance L2. Further, the concave lens (4a) is movable with regard to the convex lens (4b), to set distance L1. For this purpose the concave lens (4a) is mounted on a separate sliding delay line which is illustrated by the box (4c) and can be moved in the direction of the optical path back and forth. By choosing proper values for L1 and L2, both the position of beam focus and beam waist at the entrance of the cell (5) containing the liquid can be set independently over a wide range. Additionally, a given range can be shifted up or down, if the beam waist is increased or decreased prior entering the beam forming section.

Furthermore the order of the lenses (4a), (4b) and (4e) can be changed according to the invention. In this case the range over which the position of the beam focus and beam waist can be set is increased. For example the order (4e), (4a) and (4b) is suitable which is illustrated in FIG. 2(b). In this embodiment convex lens (4e) is mounted on a sliding delay line and can be moved in the direction of the optical path with respect to the concave lens (4a), to set distance L1. The sliding delay line of lens (4e) is illustrated by the box (4c) around the convex lens (4e). Convex lens (4e) and concave lens (4a) are mounted on a sliding delay line illustrated by box (4d) and can be moved in the direction of the optical path with respect to the convex lens (4b) to set distance L2.

In another embodiment (shown in FIG. 2 (c)) of the beam forming section (4) the concave lens (4a) is mounted on a sliding delay line and can be moved in the direction of the optical path with respect to the convex lens (4b), to set distance L1. The sliding delay line of lens (4a) is illustrated by the box (4c) around the concave lens (4a). The convex lens (4e) is mounted on a sliding delay line too and can be moved in the direction of the optical path with respect to the convex lens (4b), to set distance L2. The sliding delay line of lens (4e) is illustrated by the box (4d) around the convex lens (4e).

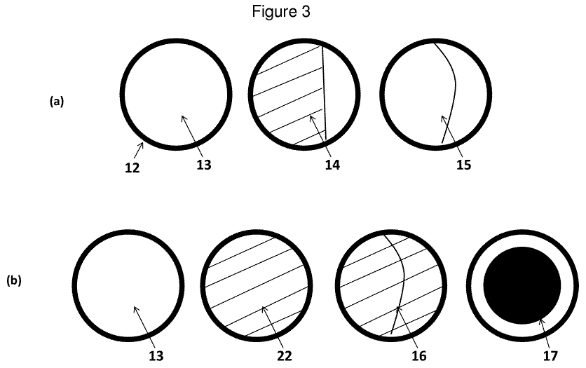

According to the invention, the cell comprising the nonlinear medium has a high flexibility. At least one end cap can comprise optical elements, such as shown in FIG. 3. The outer and/or inner threads (12) of the base caps comprise an appropriate material such as Teflon. Regarding the front end cap suitable optical elements can be a window (13), a partially broadband high reflective coated window (14), a concave lens or a curved window (15), as shown in FIG. 3(a). Regarding the rear end cap as shown in FIG. 3(b) suitable optical elements are selected from the group consisting of a window (13), a broadband high reflective coated window (14), a filter (17) or a broadband high reflective coated concave lens or focusing mirror (16).

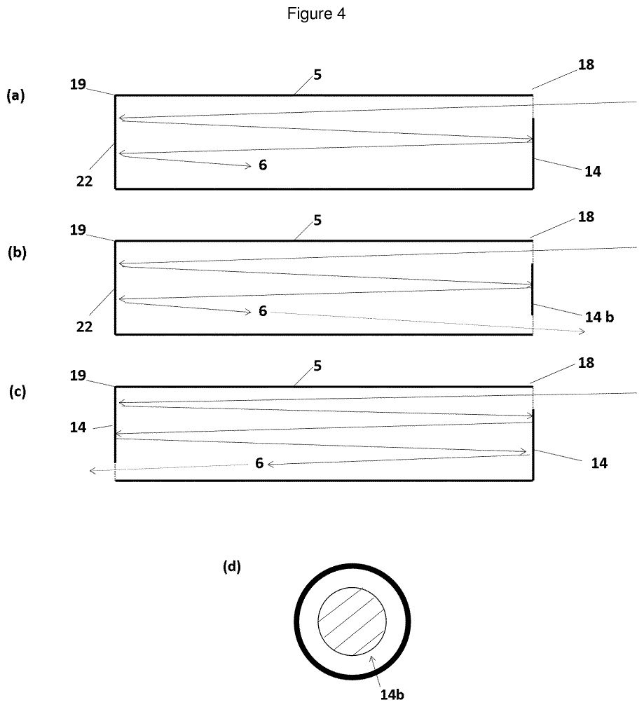

The beam forming section is also useful for larger initial pulse widths or if someone wants to use shorter cells due to limited space. Therefore, an arrangement to reflect the pulse multiple times through the cell can be used. For multiple reflections through the cell, i.e. setting very large focal positions with nods at the front and back end of the cell, the arrangements shown in FIG. 4 are used. For example in FIG. 4(a), a base cap window which is partially coated by a high reflective material (14) as front end (18) and a base cap mirror (22) as rear end (19) of the cell (5) comprising the nonlinear medium are used, to allow for multiple reflections through the cell (5). Therefore, for a cell with given length (i.e. 1 m), the focal position can be set over the whole space to nearly infinity except for focal positions close to the rear and front end of the cell (i.e. close to 1 m, 2 m, 3 m . . . ) as this would damage the optical windows. Another embodiment of this arrangement is shown in FIG. 4(b), wherein a base cap which is partially high reflectivity broadband coated in the middle (14b) is used as the front (18). A suitable base cap is shown in FIG. 4(d). The cap is partially covered with a circular high reflectivity coating, wherein the diameter of the coating is smaller in comparison to the diameter of the base cap. It is also possible that a base cap which is partially coated with a material with high reflectivity (14) is used as front end (18) and rear end (19), see FIG. 4(c). The arrangements shown in FIGS. 4(b) and 4(c) are especially useful for generation of white light continuum and/or stimulated Raman scattering. In case of white light continuum, which travels in the same direction as the incident laser beam, the arrangement shown in FIG. 4(b) is used, to couple out white light continuum which is generated after an odd number of reflections in the cell (i.e. 1, 3, 5 . . . reflections) through the front end (18). The arrangement shown in FIG. 4 (c) is used to couple out white light continuum which is generated after an even number of reflections in the cell (i.e. 2, 4, 6 . . . reflections) through the rear end (19). In case of stimulated Raman scattering, the arrangement shown in FIG. 4(b) can be used to couple out forward and backward stimulated Raman scattering which is generated after an odd number of reflections in the cell through the front end (18). The arrangement shown in FIG. 4(c) can be used to couple out stimulated Raman scattering which is generated after an even number of reflections in the cell. In the latter case, forward stimulated Raman scattering is coupled out at the rear end of the cell (19) and backward stimulated Raman scattering is coupled out at the front end of the cell (18).

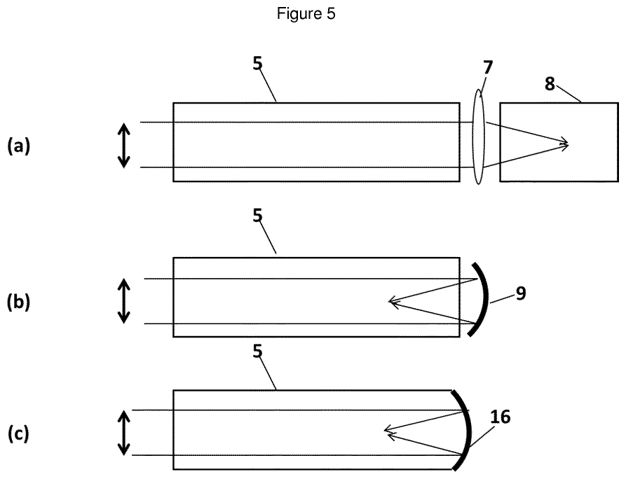

In an embodiment of the invention, the beam forming section (4) is also useful for efficient compression of very high input energies >50 mJ/pulse. In this case a generator-amplifier setup is favorable. As stated by (Nori 1998), (Schiemann, Ubachs and Hogervorst 1997) and (Yoshida, et al. 2009), the temporal shape of SBS pulses also depends on the beam waist inside the amplifier part. Therefore, the lens system of the beam forming section can be used to collimate the beam at different waist over a wide range and in small steps to prevent SBS inside the amplifier part and to optimize the temporal shape of SBS beam. If the energy of the incident laser beam is changed, the beam waist can be adapted accordingly. The optimum beam waist is also dependent on the Brillouin gain of the solvent, which is dependent on wavelength of the incident laser pulse (see table 1). Thus the waist of the laser beam has to be adapted if the wavelength of the laser beam and/or the nonlinear medium is changed. FIG. 5 shows embodiments of the invention accounting for changes in the energy and/or wavelength of the initial laser pulse and/or the type of nonlinear medium. After passing a first cell (5) comprising a nonlinear medium, the laser beam is focused by a convex lens (7) into a second cell (8) containing a nonlinear medium as shown in FIG. 5(a). The nonlinear media in the first and in the second cell are equal. Another embodiment of the invention uses a focusing mirror (9) to redirect the laser pulse back into the cell (5) containing the nonlinear medium (FIG. 5(b)). Said focusing mirror (9) can also be integrated in the rear end cap of the cell (5) as shown in FIG. 5(c). Additionally said embodiments of the invention can be used to generate stimulated Brillouin scattering, stimulated Raman scattering or a combination thereof.

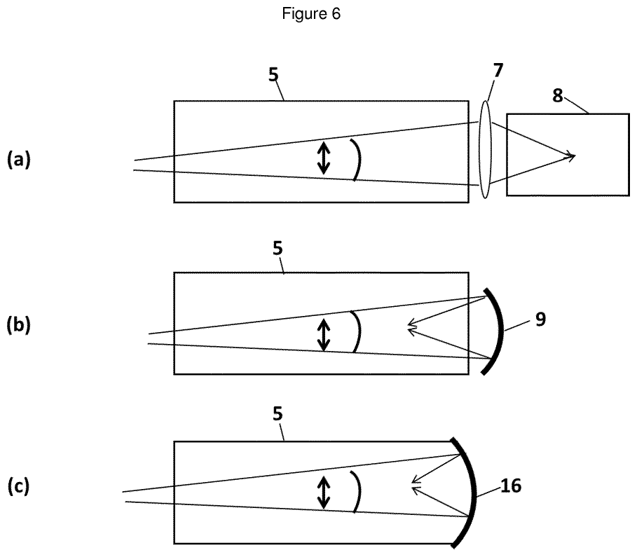

In an embodiment of the invention the lens system of the laser beam forming section can be used to produce a divergent beam, which is focused back into the same cell at the rear or can be focused into another cell, as illustrated in FIG. 6. Due to an often Gaussian-shaped temporal profile of the incident beam, the Stokes beam, generated in the focal region, faces different photon densities when traveling back through the cell. Especially, at the adjacent edge of the incident Gaussian-shaped beam, the Stokes beam faces a lower induced acoustic field and therefore amplification and temporal reshaping is decreased. In tapered waveguide geometry this situation is further declined due to the comparably large beam diameters in the front region of the cell. To compensate for the lower photon densities of the incident laser beam in the front region of the cell, a divergent beam is created via the beam forming section. Arrangements with different optical elements can be used as shown in FIG. 6. After passing a first cell (5) comprising a nonlinear medium, the laser beam is focused by a convex lens (7) into a second cell (8) containing a nonlinear medium as shown in FIG. 6(a). The nonlinear media in the first and in the second cell are equal. Another embodiment of the invention uses a focusing mirror (9) to redirect the laser pulse back into the cell (5) containing the nonlinear medium (FIG. 6(b)). Said focusing mirror (9) can also be integrated in the rear end cap of the cell (5) as shown in FIG. 6(c). Additionally said embodiments of the invention can be used to generate stimulated Brillouin scattering, stimulated Raman scattering or a combination thereof.

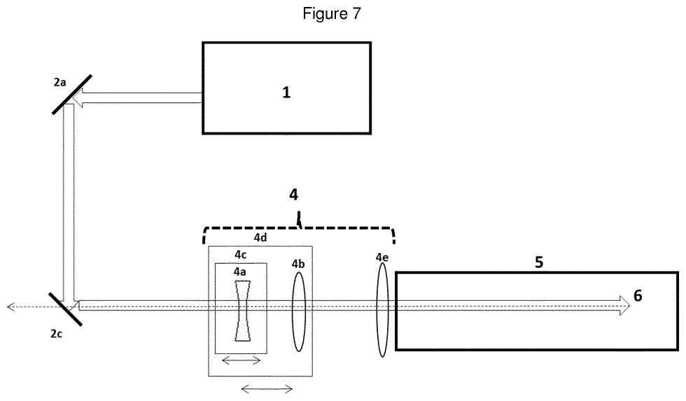

In a further embodiment the device and the method according to the invention can be used for generating stimulated Raman scattering. FIG. 7 shows the main parts of the setup for generating stimulated Raman scattering and extracting the scattered stimulated Raman radiation. The embodiment comprises a tunable pulsed laser source (1). The laser source (1) generates a first laser beam which is directed to an alignment mirror, which comprises one broadband laser mirror (2a) and one mirror with high reflectivity for the wavelength of the incident laser and low reflectivity for the Raman wavelength (2c), each having a high damage threshold. The alignment mirrors (2a) and (2c) are used to couple the first laser beam into the beam forming section and subsequently into a cuvette or cell (5). The beam forming section in the embodiment comprises 3 lenses, a concave lens (4a), a convex lens (4b) and a second convex lens (4e), wherein lens (4a) and (4b) are movable with regard to lens (4e) and lens (4a) is movable with regard to lens (4b). All 2 lenses are adjustable with regard to the optical path. Three lenses forming the beam forming section are preferred due to a higher degree of freedom i.e. independently adjusting focal position and beam waist. The beam forming section focuses the initial beam into the cell (5) which is filled with a nonlinear medium. The generation of the stimulated Raman scattering takes place in the focal region (6) inside of the cell (5). Thereby, by changing the distances of the movable lenses in the beam forming section the optimal position of the focal region inside of the cell (5) is adjustable. In FIG. 7 the backward Raman radiation leaves the cell (5) through the front end cap and is coupled out by mirror (2c).

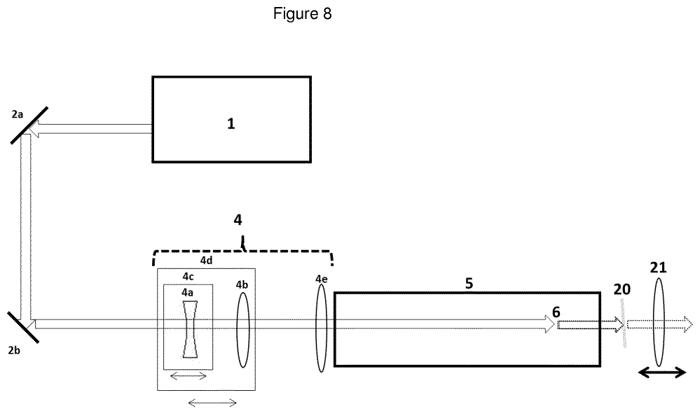

In a further embodiment the device and the method of the invention can be used for generating a white light continuum. FIG. 8 shows the main parts of the setup for generating a white light continuum. The embodiment comprises a tunable pulsed laser source (1). The laser source (1) generates a first laser beam which is directed to an alignment mirror, which comprises two broadband laser mirrors (2a), (2b) each having a high damage threshold. The alignment mirrors (2a) and (2b) are used to couple the first laser beam into the beam forming section and subsequently into a cuvette or cell (5) which comprises the nonlinear medium. The beam forming section (4) in the embodiment comprises 3 lenses, a concave lens (4a), a convex lens (4b) and a second convex lens (4e), wherein lens (4a) and (4b) are movable with regard to lens (4e) and lens (4a) is movable with regard to lens (4b). All 2 lenses are adjustable with regard to the optical path. Three lenses forming the beam forming section are preferred due to a higher degree of freedom i.e. independently adjusting focal position and beam waist. The beam forming section focuses the initial beam into the cell (5) which is filled with a pulse-compressing nonlinear medium. The generation of the white light continuum takes place in the focal region (6) inside of the cell (5). By changing the distances of the movable lenses in the beam forming section (4) the optimal position of the focal region inside of the cell (5) is adjustable. The resulted white light is traveling in the same direction as the incident beam. Therefore, the generated white light continuum is filtered from the wavelength of the incident laser beam by a filter (20). Suitable filters are short pass, band pass or most preferred notch-filters. Spatial wavelength filtering, by using at least two prisms and blocking the wavelength of the incident laser pulse between said prisms, is also possible. Afterwards the generated white light continuum pulse is collimated by a lens/lens system (21). In another embodiment of the invention the beam which leaves the cell and consists of the generated white light continuum and the incident beam is collimated by a lens/lens system before the generated white light continuum is filtered from the wavelength of the incident beam.

### EXAMPLES OF THE INVENTION

### Example 1

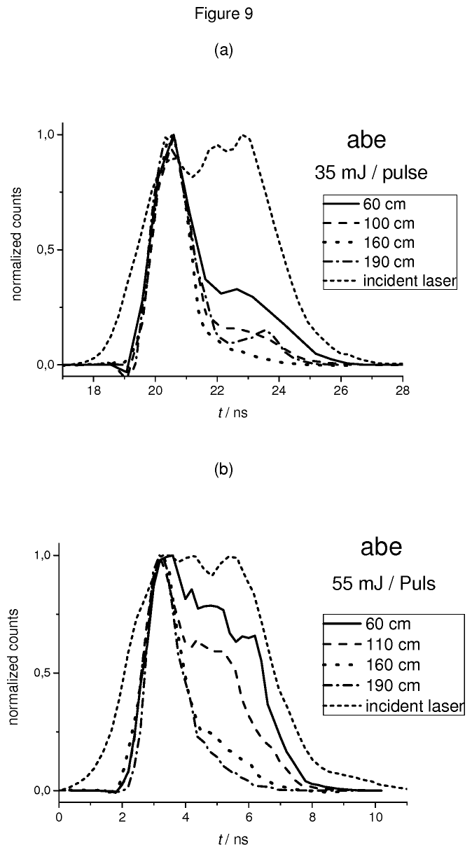

The temporal shape of stimulated Brillouin scattering was measured in dependence of the focal position at input energies of 35 mJ/pulse (FIG. 9a) and 55 mJ/pulse (FIG. 9b). The graphs 9a and 9b show the normalized counts representing the intensity of the pulse in dependence of the time. The initial laser pulse was used with a wavelength of 570 nm and a pulse length of 5 ns. The lenses of the beam forming section were used in the order 4a, 4b, 4e with the following focal values: 4a=−7.5 cm, 4b=20 cm, 4e=50 cm. Distance L2 was fixed at 20 cm and L1 was varied between 9-13 cm. Water was used as nonlinear medium, which was filtered by a 400 nm pore size filter to increase the purity of the nonlinear medium.

At this conditions the order 4a, 4b, 4e allows setting the focal position from 50 cm to nearly infinity while having a constant increased beam waist factor of 2.67 at the entrance of the cell containing the nonlinear medium. In the examples shown, the beam waist at the front window of the cell containing the nonlinear medium was approx. 1.5 cm. The optimal compression is achieved at L1=9 cm at 35 mJ/pulse input energy and L1=8 cm at 55 mJ/pulse input energy, corresponding to focal positions of 160 and 190 cm, respectively.

It can be seen that the temporal shape of the compressed pulse depends on the focal position as well as on the input energy of the laser pulse. The beam forming section is necessary to obtain optimal pulse shapes, meaning nearly Gaussian-shaped pulses. The distances of the lenses in the beam forming section have to be adjusted in dependence of the input energy of the initial pulse. The pulse length of the initial pulse was 5 ns and is clearly shortened to −2 ns.

### Example 2

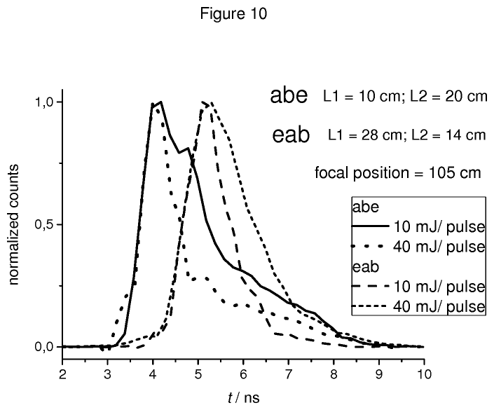

Temporal profiles of a laser pulse obtained by using stimulated Brillouin scattering as nonlinear interaction with input energies of the incident laser pulse of 10 mJ/pulse and 40 mJ/pulse, in dependence of the order of the lenses in the beam forming section, were measured. FIG. 10 shows the normalized counts representing the intensity of the pulse in dependence of the time. The initial laser pulse was used with a wavelength of 570 nm and a pulse length of 5 ns. On the one hand the lenses of the beam forming section were used in the order 4a, 4b, 4e with the following distances L1=10 cm and L2=20 cm and on the other hand in the order 4e, 4a, 4b with the distances L1=28 cm and L2=14 cm. The focal position is for both conditions approximately 105 cm. Water was used as nonlinear medium, which was filtered by a 400 nm pore size filter to increase the purity of the nonlinear medium.

At low energies the lens order 4a, 4b, 4e lead to a poor temporal beam profiles. To gain optimal compression the beam waist has to be decreased from 1.5 cm (dashed lines in FIG. 10) to 0.5 cm (solid lines in FIG. 10). Therefore, the order 4e, 4a, 4b is used. At these conditions pulses with higher energy are less compressed than low energy pulses.

### Example 3

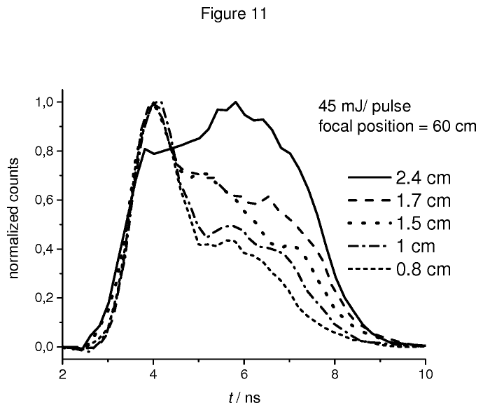

Temporal profiles of a laser pulse obtained by using stimulated Brillouin scattering as nonlinear interaction in dependence of the pulse waist of the initial laser pulse. The input energy of the laser pulses was 45 mJ/pulse, the distances L1 and L2 were adjusted in a way to maintain a constant focal position of 60 cm while varying the beam waist at the entrance of the cell. Water was used as nonlinear medium, which was filtered by a 400 nm pore size filter to increase the purity of the nonlinear medium. The pulse waist was varied between 0.8 cm and 2.4 cm. FIG. 11 shows the normalized counts representing the intensity of the pulse in dependence of the time. The dependence of the temporal shape of the compressed pulses on the waist of the initial laser pulse is clearly visible.

### Example 4

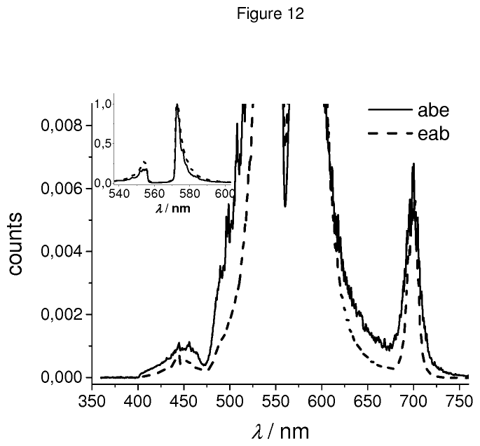

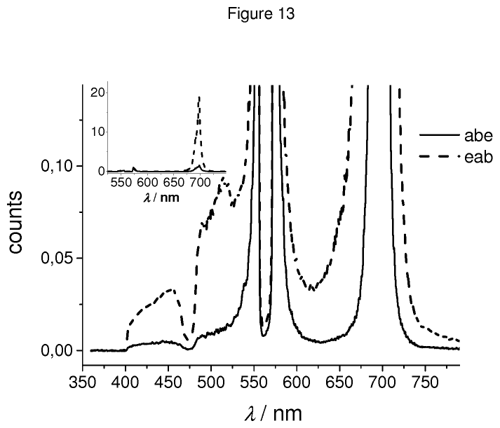

FIG. 12 and FIG. 13 show a white light continuum obtained by the method according to the invention by using broadband 566 nm input (30 mJ, width=10 nm) and smallband 564 nm input (45 mJ, width <0.01 nm), respectively. The spectra were measured by using a Notch filter with 564 nm center wavelength and 13 nm width and normalized to the intensity at the red wing of the Notch filter. The spectra shown by the solid lines were obtained by using the lens order 4a, 4b, 4e with focal values: 4a=−7.5 cm, 4b=20 cm, 4e=50 cm. For these graphs, distance L2 was set to 39 cm and L1 was set to 9 cm for both figures. The spectra shown by the dashed lines were obtained by using the lens order 4e, 4a, 4b and setting L2=18 cm and L1=31 cm for both figures. In the inset of FIG. 12 it can be seen, that in the spectral region around the pumping wavelength the lens order 4e, 4a, 4b leads to a higher signal, whereas the lens order 4a, 4b, 4e gives rise to a slightly broader spectrum, and is therefore better suitable (higher conversion efficiency of the pumping wavelength). However, when using smallband input (<0.01 nm) the same lens order 4a, 4b, 4e (L2=39 cm; L1=9 cm) leads to a very poor performance of the white light continuum, as shown by the solid lines in FIG. 13. In this case the lens order 4e, 4a, 4b (L2=18 cm; L1=31 cm) is suitable (dashed lines in FIG. 13). In the inset of FIG. 13 it can be seen that the improved white light continuum performance is accompanied by strong stimulated Raman generation around 700 nm.

### REFERENCES

Brandi, F., I. Velchev, D. Neshev, W. Hogervorst, and W. Ubachs. “A narrow-band wavelength tunable laser system delivering high-energy 300 ps pulses in the near-infrared.” Review of Scientific Instruments, 2003.
Bryce-Smith, D. Photochemistry. The chemistry society, 1979.
Damzen, M. J., V. I. Vlad, V. Babin, and A. Mocofanescu. Stimulated Brillouin Scattering Fundamentals and Applications. 2003.
He, G., and S. Liu. Physics in Nonlinear Optics. 1999.
Kong, H. J., S. K. Lee, J. W. Yoon, J. S. Shin, and S. Park. “Stimulated Brillouin scattering phase conjugate mirror and its application to coherent beam combined laser system producing a high energy, high power, high beam quality and high repetition rate output.” In Advances in Lasers and Electro Optics, 838. 2010.
Nori, J. “Development of a laser-pulse compression device based on stimulated Brillouin scattering.” University of Lund, 1998.
Räikkönen, E., G. Genty, O. Kimmelma, and M. Kaivola. “Supercontinuum generation by nanosecond dual-wavelength pumping in microstructured optical fibres.” Optics Express, 2006.
Schiemann, S., W. Ubachs, and W. Hogervorst. “Efficient temporal compression of coherent nanosecond pulses in a compact SBS generator-amplifier setup.” Vol. 33. no. 3. 1997. IEEE Journal of quantum electronics, 1997, 33 ed.
Somekawa, T., N. Manago, H. Kuze, and M. Fujita. “Differential optical absorption spectroscopy measurements of CO2 using nanosecond white light continuum.” Optical Letters, 2011: 4782-4784.
Spaulding, D. K., R. Jeanloz, B. A. Remington, D. G. Hicks, and G. W. Collins. “Nanosecond Broadband Spectroscopy for Laser-Driven Compression Experiments.”
Sutherland, R. L. Handbook of Nonlinear Optics. 2003.
Veltchev, L. T. “Stimulated Brillouin scattering pulse compression and harmonic generation: Applications to precision xuv laser spectroscopy.” Vrije Universiteit Amsterdam, 2009.
Wong, A. C. “Experimental study of stimulated Brillouin scattering in open cells and multimode optical fibres.” University of Adelaine, 2005.
Xu, X. “High power pulse UV source development and its applications.” University of New Mexico, 2014.
Yoshida, H., T. Hatae, H. Fujita, Nakatsuka N., and S. Kitamura. “A high-energy 160 ps pulse generation by stimulated Brillouin scattering from heavy fluorocarbon liquid at 1064 nm wavelength.” Optics Express, 2009.

### REFERENCE NUMBERS

1 laser source
2 alignment section
2a mirror
2b mirror
2c mirror
3 beam separation section
3a polarizer
3b waveplate
4 beam forming section
4a concave lens
4b convex lens
4e convex lens
5 cell
6 focal region
7 convex lens
8 second cell
9 focusing mirror
12 outer/inner thread of the base cap
13 window
14 partially broadband high reflectivity coated window
14b partially broadband high reflectivity coated window
15 curved window
16 focusing mirror
17 filter (base cap filter)
18 front end of the cell
19 rear end of the cell
20 filter
21 lens
22 fully broadband high reflective coated window (i.e. mirror)

1. Device for modulating a laser pulse comprising
at least one laser source (1),
a laser beam separation or outcoupling section (3),
a laser beam forming section (4) comprising at least two lenses,
a cell (5) containing a nonlinear medium and
optional a section of optical elements containing at least one lens (21) and/or at least one mirror positioned in the optical path behind the cell containing a nonlinear medium,
wherein at least one of the at least two lenses of the laser beam forming section (4) is movable in the direction of the optical path in a way that the beam waist and the focal position of the laser beam inside the cell containing the nonlinear medium are adjusted depending on the properties of the initial laser beam and the type of nonlinear medium to adjust the beam parameters.

2. Device according to claim 1, wherein the initial laser beam is generated by a laser source (1), wherein said laser source (1) is tunable or can vary with respect to the pulse energy and/or the temporal pulse shape and/or the wavelength of the pulse and/or the divergence and/or the spatial shape of the pulse.

3. Device according to claim 2, wherein the laser source (1) comprises one tunable laser or a combination of at least two lasers, wherein in said combination the at least two lasers are tunable or non tunable or one laser is tunable and the other laser is non tunable.

4. Device according to claims 1 to 3, wherein the laser source (1) is selected from a dye laser, a solid-state laser, a gas laser or an optical parametric oscillator (OPO).

5. Device according to claims 1 to 4, wherein the device comprises at least one laser beam mirror.

6. Device according to claims 1 to 5, wherein the beam separation section (3) comprises optical active materials.

7. Device according to claim 6, wherein the optical materials are selected from a group consisting of polarization selective elements, polarizing elements, mirrors with high reflectivity for the input wavelength and high transmittance for the output wavelength and prisms.

8. Device according to claim 7, wherein the polarization selective element is a polarizer, a glassplate, a nonlinear crystal or a dichrotic mirror.

9. Device according to claim 7, wherein the polarizing element is a waveplate.

10. Device according to claims 1 to 9, wherein the nonlinear medium is encapsulated by a cell (5) comprising a length in the range of 10 cm to 3 m and a diameter in the range of 1 cm to 10 cm.

11. Device according to claims 1 to 10, wherein the cell (5) containing the nonlinear medium is equipped with removable caps on the front end (18) and/or with removable caps on the back end (19).

12. Device according to claims 1 to 11, wherein the caps on the front end (18) and/or the back end (19) of the cell containing the nonlinear medium are equipped with optical active materials.

13. Device according to claim 12, wherein the optical active materials are selected from a group consisting of a mirror, a lens, a filter (17), a flat window (13), a curved window (15), a curved window with high reflective coating on the inside, a window which is at least partially coated on the inside with a high reflective material (14).

14. Device according to claim 12, wherein the curved window with high reflective coating is a focusing mirror.

15. Device according to claim 12 wherein one optical active material is a brewster angle window.

16. Device according to claims 1 to 15, wherein the optical elements of the caps are at least partially coated by an anti-reflecting material.

17. Device according to claims 1 to 16, wherein the cell (5) is at least partially coated, preferably on the inner surface, by reflecting material.

18. Device according to claims 1 to 17, wherein the nonlinear medium is a solvent or a mixture of solvents.

19. Device according to claim 18, wherein the nonlinear medium contains a solution of non-absorbance compounds.

20. Device according to claim 19, wherein the nonlinear medium is selected from a liquid crystal or ionic liquid.

21. Method for modulating a laser pulse using the device of any of claims 1 to 20 comprising the steps:
generating an initial laser beam,
optionally rotating the polarization of the laser beam,
shaping the laser beam waist,
shaping the focal position of the laser beam,
bringing the laser beam into a nonlinear medium inside a cell and
coupling out an adjusted beam,
wherein the laser beam is focused into the nonlinear medium for nonlinear interaction and the beam waist and the focal position of the beam inside the nonlinear medium are adjusted depending on the properties of the initial laser beam and the type of nonlinear medium.

22. Method of claim 21, wherein the shaping of beam waist and/or focal position of the laser pulse is performed by use of a lens system.

23. Method of claims 21 to 22, wherein the lens system to adjust the laser pulse comprises at least two lenses, wherein, preferably, at least one lens is movable.

24. Method according to claims 21 to 23, wherein the waist and/or focal position of the initial laser beam is modulated by adjusting the position of the lenses in the lens system of the beam forming section.

25. Method according to claims 21 to 24, wherein the spatial shape of the initial beam is adjusted by the beam forming section, which comprises at least two lenses which are selected from a group consisting of focusing and defocusing lenses, which are movable in the direction of the optical path.

26. Method according to claims 21 to 25, wherein the focal position and/or beam waist of the incident laser beam is adjusted by adjusting the position of the lenses in the lens system of the beam forming section in dependence of the wavelength of the initial laser beam.

27. Method according to claims 21 to 26, wherein the focal position and/or beam waist of the laser beam in the nonlinear medium is adjusted by adjusting the position of the lenses in the lens system of the beam forming section in dependence of the nonlinear medium in the cell.

28. Method according to claims 21 to 27, wherein the focal position of the laser beam in the nonlinear medium is adjusted by positioning of the at least one focusing lens and/or at least one focusing mirror comprised in the beam forming section.

29. Method according to claims 21 to 28, wherein the polarization of the initial laser beam is rotated by at least one spectrally tunable or non-tunable waveplate.

30. Method according to claims 21 to 29, wherein stimulated Brillouin scattering is generated due to nonlinear interactions between the laser pulse and the nonlinear medium.

31. Method according to claim 30, wherein the incident laser pulses are compressed to the optimal temporal pulse length and shape independent of their energies by adjusting the position of the lenses in the lens system of the beam forming section in dependence of the energy of the initial laser pulse.

32. Method according to claim 30 or 31, wherein initial laser pulses with different beam waist are compressed in the same setup.

33. Method according to claims 30 to 32, wherein initial laser pulses with different wavelength are compressed.

34. Method according to claims 30 to 33, wherein different nonlinear media are used to generate stimulated Brillouin scattering.

35. Method according to claims 30 to 34, wherein the position of the lenses in the lens system of the beam forming section is adjustable in dependence of the temporal shape and width of the incident laser beam.

36. Method according to claims 21 to 29, wherein stimulated Raman scattering is generated due to nonlinear interactions between the laser pulse and the nonlinear medium.

37. Method according to claim 36, wherein stimulated Raman scattering is generated by adjusting the position of the lenses in the lens system of the beam forming section in dependence of the energy of the initial laser pulse.

38. Method according to claims 36 to 37, wherein initial laser pulses with different wavelengths are used to generate stimulated Raman scattering.

39. Method according to claims 36 to 38, wherein different nonlinear media are used to generate stimulated Raman scattering.

40. Method according to claims 30 to 39, wherein the temporal pulse length of the initial laser pulse is longer in comparison to the pulse length of the adjusted laser pulse.

41. Method according to claims 30 to 40, wherein the spectral purity of the adjusted laser pulse is higher in comparison to the initial laser beam.

42. Method according to claims 30 to 42, wherein the position of the lenses in the lens system of the beam forming section is adjustable in dependence of the temporal shape of the incident laser beam.

43. Method according to claims 21 to 29, wherein a white light continuum is generated due to nonlinear interactions between the laser pulse and the nonlinear medium.

44. Method according to claim 44, wherein the position of the lenses in the lens system of the beam forming section is adjusted in dependence of the spectral band width of the initial laser pulse.

45. Method according to claims 44 to 45, wherein initial laser pulses with different energies are used to generate a white light continuum.

46. Method according to claims 44 to 46, wherein initial laser pulses with different wavelengths are used to generate a white light continuum.

47. Method according to claims 44 to 47, wherein different nonlinear media are used to generate a white light continuum.

48. Method according to claim 36 or 48, wherein the generated beam is collimated by optical elements in the optical path behind the cell containing a nonlinear medium and separated from the initial laser pulse by optical elements in the optical path behind said cell containing a nonlinear medium.

49. Use of the device according to any of claims 1 to 20 in a or with a conventional laser system, wherein the laser parameters of the initial laser pulse are adjustable.

50. Use of the device according to any of claims 1 to 20, wherein the temporal pulse length of the initial laser pulse is shortened.

51. Use of the device according to any of claims 1 to 20, wherein the spectral purity of the initial laser pulse is increased.

52. Use of the device according to any of claims 1 to 20, wherein the intensity profile of the initial laser pulse is improved.

53. Use of the device according to claims 1 to 20 in time resolved fluorescence spectroscopy or time resolved absorption spectroscopy or time-resolved emission spectroscopy.
